(19) United States
(12) Patent Application Publication
(10) Pub. No.: US 2025/0351841 A1
(43) Pub. Date: Nov. 20, 2025

(54) A PROCESS FOR PREPARING A MEAT ANALOGUE PRODUCT

(71) Applicant: SOCIETE DES PRODUITS NESTLE S.A., Vevey (CH)

(72) Inventors: NADJI REKHIF, Solon, OH (US); SANYASI GADDIPATI, Hudson, OH (US); DAVID KOMAREK, Hilzingen (DE)

(21) Appl. No.: 18/864,322

(22) PCT Filed: May 3, 2023
(86) PCT No.: PCT/EP2023/061673

§ 371 Date: Nov. 8, 2024

Related U.S. Application Data
(60) Provisional application No. 63/364,500, filed on May 11, 2022.

(51) Int. Cl. A23J 3/16; A23J 3/18; A23L 27/26; A23L 33/115

(52) U.S. Cl. CPC A23J 3/16; A23J 3/18; A23L 27/26; A23L 33/115

(57) ABSTRACT

The present invention relates to a process for preparing a meat analogue product comprising a textured plant protein, water, a binder, an oil-soluble flavor, an aqueous-soluble flavor and optionally a colorant, wherein the oil-based flavor is encapsulated with a vegetable fat and wherein the vegetable fat has a solid fat content in the range of 30 to 90 wt % (based on the weight of total fat) at a temperature of 30° C.

The present invention relates to a process for preparing a meat analogue product comprising a textured plant protein, water, a binder, an oil-soluble flavor, an aqueous-soluble flavor and optionally a colorant, wherein the oil-based flavor is encapsulated with a vegetable fat and wherein the vegetable fat has a solid fat content in the range of 30 to 90 wt % (based on the weight of total fat) at a temperature of 30° C.

Today's consumer demand more and more meat analogue products as substitutes for real meat-based products in their diets. Reasons for this trend are varying from ecological, to economical, ethical and more health-conscious considerations.

Typically, such meat analogue products are plant protein extrudates, which are mixed with binders, oil and fat and various colorings and flavorings. However, there are still many limitations as to product quality such in taste, texture and overall visual appearance. Today the trend is towards meat replacement products, which mimic raw meat, meaning that the consumer buys these products ‘raw’ and processes/cooks them in the kitchen in the same way as he would with a corresponding raw meat product. Hence, the consumer expects those meat analogue products also to behave in the same way as raw meat when it comes to the taste, texture, and appearance of those products during the preparation and transformation during a cooking process.

With today's available meat alternative products, however, many limitations still exist and there is still a clear and persisting need in the art to improve the quality of such meat analogue products, as to texture and particularly to taste of such products, as to before, during and after the cooking process.

From flavoring plant-based meat analogues perspective, the product developers are facing the following key challenges.
Plant proteins and fat used in meat analogues strongly interact with flavors, leading to imbalanced flavor performance or weaker stability over shelf life;
Typical oil-soluble meaty flavors such as sulfur, thiols, methyl ketones and hydrocarbons strongly interact with proteins;
There is a need to overdose flavors to ensure better flavor performance that would subsequently create stronger aroma intensity on raw meat analogue (e.g. plant-based burger, minced meat; plant-based meat balls) and lingering taste, which are not liked by consumers.

The object of the present invention is to improve the state of the art and to provide an improved solution as to meat analogue products and their process of manufacture. In particular, the object of the present invention is to provide a process for preparing meat analogue product, where the product requires to be cooked like a real raw meat product before consumption, which has an improved taste, particularly in respect to the taste of the product before, during and after the cooking process.

The object of the present invention is achieved by the subject matter of the independent claims. The dependent claims further develop the idea of the present invention.

Accordingly, the present invention provides a process for the preparation of a meat analogue product comprising a textured plant protein, water, a binder, an oil-soluble flavor, an aqueous-soluble flavor and optionally a colorant, the process comprising the steps of:
a) mixing the textured plant protein with water;
b) adding the binder, the aqueous-soluble flavor and optionally the colorants to the mix of step a);
c) optionally cooling the mass of step b);
d) encapsulation of the oil-soluble flavor with a vegetable fat and adding the encapsulated flavor after step b) or c) and further mix;
   wherein the the encapsulated flavor has a particle size between 10 to 500 microns and wherein the vegetable fat has a solid fat content in the range of 30 to 90 wt % (based on the weight of total fat) at a temperature of 30° C.

The inventors surprisingly found, that when oil-soluble flavor is encapsulated with a vegetable fat and the encapsulated flavor has a particle size between 10 to 500 microns, preferably between 10 to 300 microns, and the vegetable fat has a solid fat content in the range of 30 to 90 wt % (based on the weight of total fat) at a temperature of 30° C., that a beneficial taste effect is achieved. The encapsulated flavor protect/reduce/limit the flavor from interacting/binding with the proteins during the preparation and the storage of the finished plant-based products (ambient and chilling/freezing conditions) and (ii) allow the timely release of the flavor only during the cooking (when the fat-flavor particles would melt due to heat of the cooking) and the consumption of the final products, enhancing the performance of the flavoring agents. The small particle size of the encapsulated flavor particles would distribute evenly in the plant-based meat analogue, for example plant-based burger, in an invisible way and enable the melting of the encapsulated flavor around all the plant-based meat analogue. The encapsulation of the flavor would also allow the reduction of flavor headspace and reduce the overall aroma intensity when opening the packaged plant-based product. A too strong aroma intensity when opening the packaged plant-based product is negatively perceived by the consumer.

### DETAILED DESCRIPTION OF THE INVENTION

The present invention pertains to a process for the preparation of a meat analogue product comprising a textured plant protein, water, a binder, an oil-soluble flavor, an aqueous-soluble flavor and optionally a colorant, the process comprising the steps of:
a) mixing the textured plant protein with water;
b) adding the binder, the aqueous-soluble flavor and optionally the colorants to the mix of step a);
c) optionally cooling the mass of step b);
d) encapsulation of the oil-soluble flavor with a vegetable fat and adding the encapsulated flavor after step b) or c) and further mix;
   wherein the the encapsulated flavor has a particle size between 10 to 500 microns and wherein the vegetable fat has a solid fat content in the range of 30 to 90 wt % (based on the weight of total fat) at a temperature of 30° C.

In an embodiment the present invention further pertains to a process for the preparation of a formed meat analogue product comprising a textured plant protein, water, a binder, an oil-soluble flavor, an aqueous-soluble flavor and optionally a colorant, the process comprising the steps of:
a) mixing the textured plant protein with water;
b) adding the binder, the aqueous-soluble flavor and optionally the colorants to the mix of step a);
c) optionally cooling the mass of step b);
d) encapsulation of the oil-soluble flavor with a vegetable fat and adding the encapsulated flavor after step b) or c) and further mix;
e) shaping the mass from step d) into the formed meat analogue product
   wherein the the encapsulated flavor has a particle size between 10 to 500 microns and wherein the vegetable fat has a solid fat content in the range of 30 to 90 wt % (based on the weight of total fat) at a temperature of 30° C.

In an embodiment the present invention further pertains to a process for the preparation of a formed meat analogue product comprising a textured plant protein, water, a binder, an oil-soluble flavor, an aqueous-soluble flavor, a low melting temperature vegetable fat and a colorant, the process comprising the steps of:
a) mixing the textured plant protein with water;
b) adding the binder, the aqueous-soluble flavor and the colorants to the mix of step a);
c) optionally cooling the mass of step b);
d) adding a low melting temperature vegetable fat;
e) encapsulation of the oil-soluble flavor with a vegetable fat and adding the encapsulated flavor after step d) and further mix;
f) shaping the mass from step e) into the formed meat analogue product
   wherein the low melting temperature vegetable fat having a melting temperature between 15 to 34° C. and wherein the the encapsulated flavor has a particle size between 10 to 500 microns and wherein the vegetable fat has a solid fat content in the range of 30 to 90 wt % (based on the weight of total fat) at a temperature of 30° C.

The present invention further pertains to a process for the preparation of a meat analogue product comprising 5 to 70 wt % (weight percent of the total composition) of a textured plant protein, 30 to 70 wt % (weight percent of the total composition) of water, 0.5 to 5 wt % (weight percent of the total composition) of a binder, 0.1 to 10 wt % (weight percent of the total composition) of an oil-soluble flavor, 0.1 to 10 wt % (weight percent of the total composition) of an aqueous-soluble flavor and 0.1 to 2 wt % (weight percent of the total composition) of a colorant, the process comprising the steps of:
a) mixing the textured plant protein with water;
b) adding the binder, the aqueous-soluble flavor and the colorants to the mix of step a);
c) optionally cooling the mass of step b);
d) encapsulation of the oil-soluble flavor with a vegetable fat and adding the encapsulated flavor after step b) or c) and further mix;
   wherein the the encapsulated flavor has a particle size between 10 to 500 microns and wherein the vegetable fat has a solid fat content in the range of 30 to 90 wt % (based on the weight of total fat) at a temperature of 30° C.

In an embodiment the present invention further pertains to a process for the preparation of a formed meat analogue product comprising 5 to 70 wt % (weight percent of the total composition) of a textured plant protein, 30 to 70 wt % (weight percent of the total composition) of water, 0.5 to 5 wt % (weight percent of the total composition) of a binder, 0.1 to 10 wt % (weight percent of the total composition) of an oil-soluble flavor, 0.1 to 10 wt % (weight percent of the total composition) of an aqueous-soluble flavor and 0.1 to 2 wt % (weight percent of the total composition) of a colorant, the process comprising the steps of:
a) mixing the textured plant protein with water;
b) adding the binder, the aqueous-soluble flavor and the colorants to the mix of step a);
c) optionally cooling the mass of step b);
d) encapsulation of the oil-soluble flavor with a vegetable fat and adding the encapsulated flavor after step b) or c) and further mix;
e) shaping the mass from step d) into the formed meat analogue product
   wherein the the encapsulated flavor has a particle size between 10 to 500 microns and wherein the vegetable fat has a solid fat content in the range of 30 to 90 wt % (based on the weight of total fat) at a temperature of 30° C.

The present invention further pertains to a process for the preparation of a meat analogue product comprising 5 to 70 wt % (weight percent of the total composition) of a textured plant protein, 30 to 70 wt % (weight percent of the total composition) of water, 0.5 to 5 wt % (weight percent of the total composition) of a binder, 0.1 to 10 wt % (weight percent of the total composition) of an oil-soluble flavor, 0.1 to 10 wt % (weight percent of the total composition) of an aqueous-soluble flavor and 0.1 to 2 wt % (weight percent of the total composition) of a colorant, the process comprising the steps of:
a) mixing the textured plant protein with water;
b) adding the binder, the aqueous-soluble flavor and the colorants to the mix of step a);
c) optionally cooling the mass of step b);
d) encapsulation of the oil-soluble flavor with a vegetable fat and adding the encapsulated flavor after step b) or c) and further mix;
   wherein the encapsulation of the oil-soluble flavor comprises melting the vegetable fat and mixing the oil-soluble flavor with the melted vegetable fat and spray chilling the mixture and wherein the the encapsulated flavor has a particle size between 10 to 500 microns and wherein the vegetable fat has a solid fat content in the range of 30 to 90 wt % (based on the weight of total fat) at a temperature of 30° C.

In an embodiment the present invention further pertains to a process for the preparation of a formed meat analogue product comprising 5 to 70 wt % (weight percent of the total composition) of a textured plant protein, 30 to 70 wt % (weight percent of the total composition) of water, 0.5 to 5 wt % (weight percent of the total composition) of a binder, 0.1 to 10 wt % (weight percent of the total composition) of an oil-soluble flavor, 0.1 to 10 wt % (weight percent of the total composition) of an aqueous-soluble flavor and 0.1 to 2 wt % (weight percent of the total composition) of a colorant, the process comprising the steps of:
a) mixing the textured plant protein with water;
b) adding the binder, the aqueous-soluble flavor and the colorants to the mix of step a);
c) optionally cooling the mass of step b);
d) encapsulation of the oil-soluble flavor with a vegetable fat and adding the encapsulated flavor after step b) or c) and further mix;
e) shaping the mass from step d) into the formed meat analogue product
   wherein the encapsulation of the oil-soluble flavor comprises melting the vegetable fat and mixing the oil-soluble flavor with the melted vegetable fat and spray chilling the mixture and wherein the the encapsulated flavor has a particle size between 10 to 500 microns and wherein the vegetable fat has a solid fat content in the range of 30 to 90 wt % (based on the weight of total fat) at a temperature of 30° C.

In an embodiment the present invention further pertains to a process for the preparation of a formed meat analogue product comprising 5 to 70 wt % (weight percent of the total composition) of a textured plant protein, 30 to 70 wt % (weight percent of the total composition) of water, 0.5 to 5 wt % (weight percent of the total composition) of a binder, 0.1 to 10 wt % (weight percent of the total composition) of an oil-soluble flavor, 0.1 to 10 wt % (weight percent of the total composition) of an aqueous-soluble flavor, 0.1 to 2 wt % (weight percent of the total composition) of a colorant and 1 to 20 wt % (weight percent of the total composition) of a low melting temperature vegetable fat, the process comprising the steps of:
a) mixing the textured plant protein with water;
b) adding the binder, the aqueous-soluble flavor and the colorants to the mix of step a);
c) optionally cooling the mass of step b);
d) adding the low melting temperature vegetable fat;
e) encapsulation of the oil-soluble flavor with a vegetable fat and adding the encapsulated flavor after step b) or c) and further mix;
f) shaping the mass from step d) into the formed meat analogue product
   wherein the low melting temperature vegetable fat having a melting temperature between 15 to 34° C. and wherein the encapsulation of the oil-soluble flavor comprises melting the vegetable fat and mixing the oil-soluble flavor with the melted vegetable fat and spray chilling the mixture and wherein the encapsulated flavor has a particle size between 10 to 500 microns and wherein the vegetable fat has a solid fat content in the range of 30 to 90 wt % (based on the weight of total fat) at a temperature of 30° C.

The present invention further pertains to a meat analogue product comprising a textured plant protein, water, a binder, an oil-soluble flavor, an aqueous-soluble flavor and optionally a colorant, wherein the oil-soluble flavor is encapsulated with a vegetable fat and wherein the encapsulated flavor has a particle size between 10 to 500 microns and wherein the vegetable fat has a solid fat content in the range of 30 to 90 wt % (based on the weight of total fat).

In an embodiment the present invention further pertains to a meat analogue product comprising a textured plant protein, water, a binder, an oil-soluble flavor, an aqueous-soluble flavor and optionally a colorant, wherein the oil-soluble flavor is encapsulated with a vegetable fat and wherein the encapsulated flavor has a particle size between 10 to 500 microns and wherein the vegetable fat has a solid fat content in the range of 30 to 90 wt % (based on the weight of total fat) at a temperature of 30° C.

In an embodiment the present invention relates to a formed meat analogue product comprising 5 to 70 wt % (weight percent of the total composition) of a textured plant protein, 30 to 70 wt % (weight percent of the total composition) of water, 0.5 to 5 wt % (weight percent of the total composition) of a binder, 0.1 to 10 wt % (weight percent of the total composition) of an oil-soluble flavor, 0.1 to 10 wt % (weight percent of the total composition) of an aqueous-soluble flavor and optionally 0.1 to 2 wt % (weight percent of the total composition) of a colorant, wherein the oil-soluble flavor is encapsulated with a vegetable fat and wherein the vegetable fat has a solid fat content in the range of 30 to 90 wt % (based on the weight of total fat) at a temperature of 30° C.

Preferably, the meat analogue product of the present invention is raw, meaning that the product was not cooked during its process of manufacture.

The term “meat analogue product”, sometimes also called meat alternative, meat substitute, mock meat, faux meat, imitation meat or vegetarian meat, refers herein to a food product, exclusively made from vegetarian ingredients, and which has qualities as to appearance, taste, flavor, and texture as the corresponding real meat product. In one preferred embodiment of the present invention, the meat analogue product does not comprise an ingredient from an animal origin. The product of the present invention is a vegetarian or vegan food product.

The term “formed” means that the meat analogue product has been shaped, e.g. via molding, pressing or casting. In an embodiment the formed meat analogue product is selected from the group of a meat analogue sausage, a meat analogue burger patty, a meat analogue ball or a meat analogue roll, a minced meat analogue, a kebab meat analogue, preferably a meat analogue burger patty, a meat analogue ball or a meat analogue roll, more preferably a meat analogue burger patty.

The term “textured plant protein” is referred in the literature also as ‘texturized plant’ or ‘texturized vegetable protein’ (TVP) or high moisture extrudates (HME). It typically refers to a defatted plant protein flour, such as for example defatted soy flour or soy concentrate, which is processed e.g. by extrusion into chunks or flakes.

In an embodiment of the present invention the process for preparing a meat analogue product comprises between 30 to 70 wt % (weight percent of the total composition) of water, preferably between 35 to 70 wt %, preferably between 40 to 70 wt %, preferably between 45 to 70 wt %, preferably between 50 to 70 wt %, preferably between 35 to 65 wt %, preferably between 40 to 65 wt %, preferably between 45 to 65 wt %, preferably between 50 to 65 wt %, preferably between 55 to 70 wt %, preferably between 55 to 65 wt % (weight percent of the total composition).

In an embodiment of the present invention, the textured plant protein of the meat analogue product is selected from soy bean protein, pea protein, lentil protein, lupin bean protein, wheat gluten, or a combination thereof. Further appropriate protein sources may be proteins from beans such as green, red or black beans, chickpeas, fava beans, spirulina, or from chia, quinoa or hemp seeds. More preferably the textured plant protein of the meat analogue product is selected from soy bean protein, pea protein or a combination thereof, most preferably soy bean protein.

In one preferred embodiment of the present invention the process for preparing a meat analogue product comprises between 5 to 70 wt % (weight percent of the total composition) of textured plant protein, preferably between 10 to 70 wt %, preferably between 15 to 70 wt %, preferably between 10 to 65 wt %, preferably between 15 to 65 wt %, preferably between 20 to 70 wt %, preferably between 20 to 65 wt %, preferably between 20 to 60 wt %, preferably between 25 to 70 wt %, preferably between 25 to 65 wt %, preferably between 25 to 60 wt %, preferably between 30 to 65 wt %, preferably between 30 to 60 wt % (weight percent of the total composition).

In an embodiment of the present invention the process for preparing a meat analogue product comprises between 40 to 70 wt % (weight percent of the total composition) of water, preferably between 45 to 65 wt % (weight percent of the total composition).

The term “oil-soluble flavor” according to this invention is a flavor capable to be soluble in oil or capable to be miscible in oil, preferably the oil-soluble flavor is an oil-soluble meaty flavor. In an embodiment of the present invention the meat analogue product comprises an oil-soluble flavor selected from aroma compounds pertaining to the groups of aldehydes, alcohols, acids, esters, sulphur compounds, pyranones, pyrazines, lactones, pyrrols, pyridines, ethers, amines aromatic heterocycles, furans, furanones, ketones, terpenes, phenols or combinations thereof.

In an embodiment the process for preparing a meat analogue product according to the invention comprise 0.5 to 10 wt % oil-soluble based flavor, preferably 0.5 to 7 wt %, preferably 0.5 to 5 wt %, preferably 0.7 to 10 wt %, preferably 0.7 to 5 wt % (by weight of the composition). The meat analogue product according to the invention comprise 0.5 to 10 wt % aqueous and oil soluble flavor, preferably 0.5 to 7 wt %, preferably 0.5 to 5 wt %, preferably 0.7 to 10 wt %, preferably 0.7 to 5 wt % (by weight of the composition).

The term “aqueous-soluble flavor” according to this invention is a flavor capable to be soluble in water. In an embodiment of the present invention the meat analogue product comprises at least one aqueous soluble flavor selected from the group of salt, sugar, vinegar, yeast extract, vegetable powder, bacterial extract, vegetable extract, acid or combinations thereof. The process for preparing a meat analogue product according to the invention comprise 0.5 to 10 wt % (by weight of the composition), 0.5 to 7 wt %, preferably 0.5 to 5 wt %, preferably 0.7 to 10 wt %, preferably 0.7 to 5 wt % (by weight of the composition). A bacterial extract is described within WO2009040150 or WO2010105842. A vegetable extract is described within WO2013092296.

The term “encapsulation” means that flavor is trapped within fat. In an embodiment encapsulation comprises melting the fat and mixing the flavor with the melted fat and spray chilling the mixture. In a preferred embodiment encapsulation comprises melting the fat and mixing the oil-soluble flavor with the melted fat and spray chilling the mixture. In an embodiment encapsulation of oil-soluble flavor comprises the steps of:
i) mixing the oil-soluble flavor with a vegetable oil;
ii) melting the fat;
iii) adding the mixture of step i) to the melted fat of step ii);
iv) spray chilling the mixture of step iii)

The term “spray chilling” means solidifying an atomized liquid spray into particles. Also referred to as spray cooling, spray congealing, or prilling, this process is suitable for making particles from a few microns to several millimetres.

In an embodiment of the present invention 0.1 to 40 wt % (based on the encapsulated oil-soluble flavor) of oil-soluble flavor are encapsulated with 60 to 99.9 wt % of fat (based on the encapsulated oil-soluble flavor), preferably 0.5 to 40 wt % (based on the encapsulated oil-soluble flavor) of oil-soluble flavor are encapsulated with 60 to 99.5 wt % of fat (based on the encapsulated oil-soluble flavor), 0.5 to 35 wt % (based on the encapsulated oil-soluble flavor) of oil-soluble flavor are encapsulated with 65 to 99.5 wt % of fat (based on the encapsulated oil-soluble flavor), 1 to 35 wt % (based on the encapsulated oil-soluble flavor) of oil-soluble flavor are encapsulated with 65 to 99 wt % of fat (based on the encapsulated oil-soluble flavor), 5 to 35 wt % (based on the encapsulated oil-soluble flavor) of oil-soluble flavor are encapsulated with 65 to 95 wt % of fat (based on the encapsulated oil-soluble flavor), 10 to 35 wt % (based on the encapsulated oil-soluble flavor) of oil-soluble flavor are encapsulated with 65 to 90 wt % of fat (based on the encapsulated oil-soluble flavor).

In one embodiment of the present invention, the fat is a vegetable fat, wherein the vegetable fat has a solid fat content in the range of 30 to 90 wt % (based on the weight of total fat) at a temperature of 30° C., preferably in the range of 35 to 90 wt % at a temperature of 30° C., preferably in the range of 35 to 85 wt % at a temperature of 30° C., preferably in the range of 40 to 90 wt % at a temperature of 30° C., preferably in the range of 45 to 90 wt % at a temperature of 30° C., preferably in the range of 50 to 90 wt % at a temperature of 30° C., preferably in the range of 55 to 90 wt % at a temperature of 30° C., preferably in the range of 50 to 85 wt % at a temperature of 30° C., preferably in the range of 55 to 85 wt % at a temperature of 30° C. In case the solid fat content is below 35 wt % the encapsulation with fat is not working as the encapsulated oil-soluble flavor will be pasty and not flowable anymore. In an embodiment the vegetable fat is selected from the group of palm stearin, shea stearin, mango stearin or a combination thereof.

In an embodiment the vegetable fat has a melting point between 35 to 80° C., preferably between 40 to 80° C., preferably between 40 to 75° C., preferably between 45 to 75°, preferably between 40 to 70°, preferably between 45 to 70°, preferably between 50 to 70°, preferably between 55 to 75°, preferably between 55 to 70°, preferably between 55 to 65°.

In a preferred embodiment of the present invention, the encapsulated flavor has an average particle size below 500 μm, preferably below 400 μm, preferably below 300 μm, preferably below 250 μm, preferably below 200 μm, preferably below 190 μm, preferably below 180 μm, preferably between 20 to 500 μm, preferably between 20 to 400 μm, preferably between 20 to 300 μm, preferably between 20 to 250 μm, preferably between 20 to 200 μm, preferably between 30 to 500 μm, preferably between 30 to 400 μm, preferably between 30 to 300 μm, preferably between 30 to 250 μm, preferably between 30 to 190 μm, preferably between 30 to 180 μm, preferably between 50 to 500 μm, preferably between 50 to 400 μm, preferably between 50 to 300 μm, preferably between 50 to 250 μm, preferably between 50 to 200 μm, preferably between 50 to 190 μm, preferably between 100 to 500 μm, preferably between 100 to 400 μm, preferably between 100 to 300 μm, preferably between 100 to 250 μm, preferably between 100 to 200 μm, preferably between 100 to 190 μm.

“Average particle size” is defined herein as meaning that 90% of all particles of a batch of particles fall within a particular defined size range in [μm]. The size of the particles were herein determined by sieving through appropriate sieves or a mesh.

In one embodiment of the present invention, the binder of the meat analogue product comprises a cellulose, a fiber, a starch, an un-textured protein isolate, or a combination thereof, preferably a cellulose, a fiber, a gelatinized starch, an un-textured protein isolate, or a combination thereof. In one preferred embodiment of the present invention the meat analogue product comprises between 0.5 to 5 wt % (weight percent of the total composition) of the binder, preferably between 1 to 3 wt %, more preferably between 1.5 to 2.5 wt % (weight percent of the total composition). In one preferred embodiment of the present invention, the binder is methyl-cellulose. In one preferred embodiment of the present invention the meat analogue product comprises between 1 to 3 wt % (weight percent of the total composition) of methyl-cellulose, preferably between 1.25 to 2.5 wt %, more preferably between 1.5 to 2.25 wt % (weight percent of the total composition).

“Gelatinized starch” can be sourced directly as gelatinized starch or can be achieved by cooking native starch with water.

“Un-textured plant protein isolate” refers to a protein isolate, which did not undergo a texturing process such as for example through extrusion.

Preferably, the binder used in the meat analogue product is a paste. A “paste” is a soft plastic composition, made with the cited ingredients and water, and which constitute the binder in the present invention.

In one other embodiment of the present invention, the colorant is selected from bell pepper, beetroot, carrot, black current, malted barley powder or combination thereof. In one embodiment of the present invention the meat analogue product comprises between 0.1 to 5 wt % (weight percent of the total composition) of colorants, preferably between 0.1 to 3 wt % (weight percent of the total composition).

In an embodiment the low melting temperature vegetable fat is a pure fat or blend of fat and oil and has a melting point below 35° C., preferably below 30° C., preferably between 15 to 34° C., preferably between 15 to 30°, preferably between 20 to 30°, preferably between 20 to 34°. In an embodiment of the present invention the low melting temperature vegetable fat is selected from coconut fat, cocoa butter, palm fat, shea butter, or a combination thereof.

In one embodiment of the present invention, the formed meat analogue product comprises between 0.5 to 20 wt % low melting temperature vegetable fat (weight percent of the total composition), preferably between 1 to 10 wt %, preferably between 1 to 8 wt %, preferably between 2 to 10 wt %, preferably between 2 to 8 wt %, preferably between 3 to 7 wt % (weight percent of the total composition). In a preferred embodiment the low melting temperature fat is added in form of fat flakes.

In a preferred embodiment of the present invention, the low melting temperature vegetable fat having an average particle size of 0.5-4.5 mm. In a more preferred embodiment of the present invention, the low melting temperature vegetable fat has an average particle size between 1-3 mm. The presence of those particles significantly help to improve the visual aspect of the marbled formed meat analogue product.

“Average particle size” is defined herein as meaning that 90% of all particles of a batch of particles fall within a particular defined size range. The size of the particles were herein determined by laser scattering particle sizer equipment. The particle sizes were calculated with the Fraunhofer approximation.

In one other embodiment of the present invention, after a heat treatment at 80° C. for at least 5 minutes, the marbled aspect of the formed meat analogue product is not visible anymore. This should again mimic the process and visual effect when cooking a real fat-marbled meat product.

In an embodiment of the present invention, the meat analogue product further comprises oil. The oil is liquid at a temperature below 20° C.

In one embodiment of the present invention, the oil is a vegetable oil selected from rapeseed oil, sunflower oil, cotton seed oil, peanut oil, soya oil, olive oil, coconut oil, algal oil, safflower oil, corn oil, rice bran oil, sesame oil, hazelnut oil, avocado oil, almond oil, walnut oil or a combination thereof, preferably rapeseed oil.

In one embodiment of the present invention, the meat analogue product comprises between 0.5 to 12 wt % oil (weight percent of the total composition), preferably between 1 to 10 wt %, preferably between 2 to 7 wt %.

The term “raw” for the present invention means ‘un-cooked’.

In one important embodiment of the present invention, the meat analogue product is raw and requires cooking before consumption. The meat analogue product of the present invention is intended to mimic raw meat products, which are commercialized as such and are subsequently cooked by the consumer or a professional food out-let. Hence, the meat analogue product of the present invention is raw, meaning that it has not previously been cooked. It is commercialized raw and required to be cooked thereafter by a consumer or a direct food provider.

Those persons skilled in the art will understand that they can freely combine all features of the present invention disclosed herein, described for the different embodiments of the present invention. Further advantages and features of the present invention are apparent from the examples.

### Example 1: Encapsulation of Flavor

Containers with ˜200 g of palm stearin were placed in a lab oven set to 75° C. After the fat was completely melted oil-soluble flavor (for example meaty flavor, Grilled flavor, Roast flavor, sulfur flavor, chicken flavor, pork flavor or a combination thereof) was added. After hand mixing each flavor addition, beginning with the lowest level (i.e. 2.5% w/w), approximately 20 g of the fat-flavor solution was then poured into an aluminum weigh pan. Formulas of increasing flavor concentrations were generated by adding the appropriate amount of flavor to the remaining solution.

A Niro Mobile Minor spray dryer re-configured for two-fluid prilling was used to generate all samples. Atomization was accomplished via a two-fluid nozzle operating at 30 psi. Throughput of the melt was limited by the head pressure from the feed reservoir and the atomization air in the nozzle. The prilling vessel, pipes, nozzle, and atomization air were heat traced and regulated to ˜75° C. Liquid nitrogen was used to cool the dryer to −10-0° C. during all trials. Prills were collected at the bottom of the dryer in trays of liquid nitrogen.

Examples 2 to 7:
Different encapsulated oil-soluble flavor have
been prepared according to example 1.

| | | | | | | Comp. |
|---|---|---|---|---|---|---|
| | Ex. 2 | Ex. 3 | Ex. 4 | Ex. 5 | Ex. 6 | Ex. 7 |
| Fat (wt %) | 88.75 | 97.5 | 80 | 85 | 70 | 50 |
| Flavor | 11.25 | 2.5 | 20 | 15 | 30 | 50 |
| (wt %) | | | | | | |
| Particle | 50 | 30 | 100 | 80 | 270 | 550 |
| size [μm] | | | | | | |
| flowability | + | + | + | + | + | − |
| | | | | | | Pasty |

In case the particle size is above 500 μm a good flowability of the encapsulated flavor is not given any more resulting in a pasty encapsulated oil-soluble flavor.

### Example 8: Burger Preparation

The preparation of the meat analogue burger is as follows
1. Prepare methyl cellulose binder emulsion by Mix oil and methyl cellulose in a Stephan mixer with slow speed, then add water, and mix at medium speed until fluffy. Take emulsion out of mixer.
2. Hydrate high moisture extruded soy pieces by adding in Stephan mixer with dull blade. Mix water, colors, water soluble flavors, add to the HME and mix until pieces are uniformly colored.
3. Add back methocel emulsion, mix with slow speed. Cool mass until below 10 C.
4. Add low melting temperature fat together with the encapsulated flavor and mix with slow speed.
5. The mass is moulded into patty shape with a cross-sectional diameter of 8 to 12 cm and 10 to 20 mm height, which is afterwards chilled or frozen

Alternative to high moisture extrudates (HME) commercially sourced textured plant protein (TVP) are wetted with water.

Examples 9 to 13: Sensory assessment of encapsulated flavor
A Reference plant-based burger using a non-encapsulated grilled
flavor at 1% was prepared and compared to different plant-
based burger prototypes containing different levels of encapsulated
oil-soluble flavor. For encapsulation a palm fat having melting
point between 50-65° C. have been used.

| | Comp. | Ex. | Ex. | Ex. | Ex. |
|---|---|---|---|---|---|
| | Ex 9 | 10 | 11 | 12 | 13 |
| Texturized soy protein | 50.5 | 50.5 | 50.5 | 50.5 | 50.5 |
| water | 29.6 | 29.6 | 29.8 | 29.9 | 30 |
| MC | 1.5 | 1.5 | 1.5 | 1.5 | 1.5 |
| Colors | 1 | 1 | 1 | 1 | 1 |
| Aqueous flavor | 1 | 1 | 1 | 1 | 1 |
| Low melting temperature Fat | 13.4 | 11.06 | 11.5 | 11.7 | 11.9 |
| (coconut fat) | | | | | |
| Starch | 1 | 1 | 1 | 1 | 1 |
| Vinegar | 1 | 1 | 1 | 1 | 1 |
| Oil based Flavor (non | 1 | — | — | — | — |
| Encapsulated) | | | | | |
| Oil based Flavor | 0 | 3.34 | 2.7 | 2.4 | 2.1 |
| (Encapsulated at 30% load) | | | | | |
| Total | 100 | 100 | 100 | 100 | 100 |
| Amount of oil-soluble flavor | 1 | 1 | 0.8 | 0.7 | 0.6 |
| Amount of palm fat | 0 | 2.34 | 1.9 | 1.7 | 1.5 |

All 8 technical sensory assessors observed a significant reduction in overall aroma intensity when sniffing the uncooked burger with 1% spray chilled encapsulated flavor vs control (non-encapsulated flavor).

Technical sensory assessment of plant-based burger containing 40% less beef flavor (0.6%) vs. the Reference burger containing the full amount of non-encapsulated flavor (1%), showed pretty similar sensory profile indicating that spray chilled oil-soluble flavor used in plant-based burger could deliver same sensory profile as reference at lower dosage (˜40% reduction). This is most likely due to the protection of the flavor molecules in the fat moisty protecting them from interacting with the burger plants proteins.

1. A process for the preparation of a meat analogue product comprising a textured plant protein, water, a binder, an oil-soluble flavor, an aqueous-soluble flavor comprising the steps of:
a) mixing the textured plant protein with water;
b) adding the binder, and the aqueous-soluble flavor to the mix of step a);
c) encapsulation of the oil-soluble flavor with a vegetable fat and adding the encapsulated flavor after step b) and further mix; and
wherein the the encapsulated flavor has a particle size between 10 to 500 microns and wherein the vegetable fat has a solid fat content in the range of 30 to 90 wt % (based on the weight of total fat) at a temperature of 30° C.

2. The process for the preparation of a meat analogue product according to claim 1, which does not comprise an ingredient from an animal origin.

3. The process for the preparation of a meat analogue product according to claim 1, wherein the textured plant protein is selected from the group consisting of soy bean protein, pea protein, lentil protein, lupin bean protein, wheat gluten, and a combination thereof.

4. The process for the preparation of a meat analogue product according to claim 1, wherein the textured plant protein is in an amount of between 5 to 70 wt % (weight percent of the total composition).

5. The process for the preparation of a meat analogue product according to claim 1, wherein the meat analogue product is a formed meat analogue product comprising shaping the mass into the formed meat analogue product.

6. The process for the preparation of a meat analogue product according to claim 1, wherein the binder is selected from the group consisting of a cellulose, a fiber, a starch, a gelatinized starch, an un-textured protein, and a combination thereof.

7. The process for the preparation of a meat analogue product according to claim 1, wherein the vegetable fat has a melting point between 35 to 80° C.

8. The process for the preparation of a meat analogue product according to claim 1, wherein the meat analogue product further comprises low melting temperature vegetable fat having a melting temperature between 20 to 34° C. and wherein the meat analogue product has a visual marbled aspect due to the presence of the low melting temperature vegetable fat.

9. The process for the preparation of a meat analogue product according to claim 8, wherein the low melting temperature vegetable fat is selected from the group consisting of coconut fat, palm fat, shea butter, cocoa butter and a combination thereof.

10. The process for the preparation of a meat analogue product according to claim 1, wherein the encapsulation of oil-soluble flavor comprises melting the fat and mixing the oil-soluble flavor with the melted fat and spray chilling the mixture.

11. The process for the preparation of a meat analogue product according to claim 1, wherein the encapsulation of oil-soluble flavor comprises the steps of:
i) mixing the oil-soluble flavor with a vegetable oil;
ii) melting the fat;
iii) adding the mixture of step i) to the melted fat of step ii); and
iv) spray chilling the mixture of step iii)

12. The process for the preparation of a meat analogue product according to claim 1, wherein between 0.1 to 40 wt % (based on the encapsulated oil-soluble flavor) of oil-soluble flavor are encapsulated with 60 to 99.9 wt % of fat (based on the encapsulated oil-soluble flavor).

13. A meat analogue product comprising a textured plant protein, water, a binder, a flavor, and vegetable fat and or fat wherein the flavor is encapsulated with a fat and wherein the encapsulated flavor has a particle size between 10 to 300 microns and wherein the fat has a melting point between 35 to 85° C.

14. A meat analogue product comprising 5 to 70 wt % (weight percent of the total composition) of a textured plant protein, 30 to 70 wt % (weight percent of the total composition) of water, 0.5 to 5 wt % (weight percent of the total composition) of a binder, 0.1 to 10 wt % (weight percent of the total composition) of an oil-soluble flavor, 0.1 to 10 wt % (weight percent of the total composition) of an aqueous-soluble flavor and optionally 0.1 to 2 wt % (weight percent of the total composition) of a colorant, wherein the oil-soluble flavor is encapsulated with a vegetable fat and wherein the vegetable fat has a solid fat content in the range of 30 to 90 wt % (based on the weight of total fat) and a melting point between 35 to 85° C.
